(19) United States
(12) Patent Application Publication
(10) Pub. No.: US 2006/0145859 A1
(43) Pub. Date: Jul. 6, 2006

(54) RFID antenna assembly with integrated status indicator

(76) Inventor: Joshua Posamentier, Oakland, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/014,939

(22) Filed: Dec. 17, 2004

(51) Int. Cl. G08B 13/14

(52) U.S. Cl. 340/572.7

(57) ABSTRACT

According to some embodiments, indicator circuitry is integrated into a coaxial antenna cable of a radio frequency identification (RFID) reader. The indicator circuitry includes an injected DC offset to power one or more visual or audio indicators without interfering with a radio frequency (RF) signal received or transmitted on the antenna.

### BACKGROUND

### Description of the Related Art

Radio frequency identification (RFID) technology is well known. RFID systems may be utilized for inventory control and tracking, asset tracking and recovery, tracking goods in supply chains, among other things. An RFID tag attached to an item may be used to store information that may be used for security, access control, and/or authentication purposes.

An RFID tag may be an integrated circuit with a tag insert or inlay including an integrated circuit attached to an antenna. An RFID reader/writer (to be referred to as simply an RFID reader) sends out electromagnetic waves to an RFID tag that induce a current in the tag's antenna. RFID readers may be used to read information from an RFID tag. RFID readers may also be used to write information to the RFID tag. The RFID reader may be a fixed device or a portable device. RFID systems may use many different frequencies, but generally the most common are low (˜125 KHz), high (13.56 MHz), ultra-high (850-950 MHz), and microwave (2.4-5 Ghz).

An RFID reader may utilize multiple antenna ports. Each RFID reader port may include one antenna that both transmits and receives or two antenna elements, each of which only transmits or receives but are switched in tandem as a pair. A four port RFID reader may have four antenna elements and one active set of transmit and receive circuitry and a multiplexer which would, at any given time, leave several antennas unused.

### BRIEF DESCRIPTION OF THE DRAWINGS

The present invention may be better understood, and its numerous features and advantages made apparent to those skilled in the art by referencing the accompanying drawings.

FIG. 1 illustrates RFID system according to an embodiment of the present invention.

FIG. 2 illustrates portions of a RFID reader according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, state machine and the like that manipulate and/or transform data represented as physical, such as electronic, quantities into other data similarly represented as physical quantities.

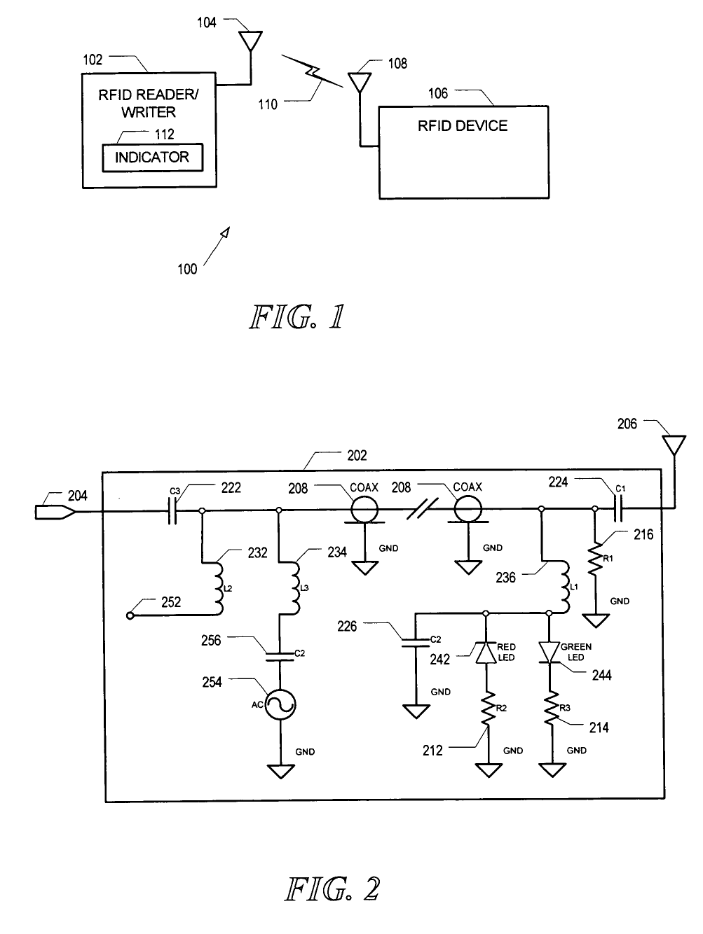

FIG. 1 illustrates an RFID system according to an embodiment of the present invention. System 100 includes a radio frequency identification (RFID) reader 102 having one or more antennas 104 and an RFID device 106 having one or more antennas 108. Any of a number of different low profile antenna types may be used for antennas 104 and 106 including, for example, a dipole, a loop, a patch, and/or others.

To access RFID device 106, an interrogation signal may be transmitted by RFID reader 102 in a vicinity of RFID device 106. Upon receipt of the interrogation signal, RFID device 106 may update stored information. RFID device 106 may send a status or confirmation message back to RFID reader 102 via RF signal 110.

RFID reader 102 includes one or more indicators 112 coupled to RFID antenna 104. Indicators 112 are integrated into and electrically coupled to antenna 104, but do not interfere with the sending or receiving of RF signals on antenna 104. Indicators 112 may include one or more light emitting diodes (LEDs), one or more speakers, or any other such visual and/or audio indicators. Indicators 112 are used to indicate a status condition, for example, of RF signal 110 or antenna 104. For example, indicators 112 may indicate a signal strength of RF signal 110, a successful tag read status, an active status of antenna 104, a successful tag read count, and the like.

FIG. 2 illustrates portions of an RFID reader, for example, RFID reader 102, according to an embodiment of the present invention. Indicator circuitry 202 is serially connected between transmit/receive port 204 and antenna 206. Indicator circuitry 202 includes coaxial antenna cable 208 and several passive components including resistors 212, 214, and 216, capacitors 222, 224, and 226, and inductors 232, 234, and 236 built into a single assembly. Coaxial antenna cable 208 is an extension of antenna 206. Indicator circuitry 202 also includes two visual indicators, light emitting diodes 242 and 244. Any number and type of indicator may be used, visual, audio and the like.

As illustrated in FIG. 2, LEDs 242 and 244 are powered via the coaxial antenna cable 208. A DC offset voltage 252 is injected into the coaxial antenna cable 208. The polarity of the injected DC level determines which of LEDs 242 and 244 is illuminated, if any. Resistors 212 and 214 are current limiting resistors for LEDs 242 and 244. Capacitors 222 and 224 are DC blocks for transmit/receive port 204 and antenna 206, respectively. Resistor 216 is an antenna sense resistor and should be small enough to outweigh any reverse current, for example, approximately 100 microamps, from LEDs 242 and 244 and should be measurable at a given offset voltage, for example, less than 600 mV. Inductors 232 and 236 are RF blocks for the DC Offset/DC Current measurement circuitry and LEDs 242 and 244.

According to an embodiment of the present invention, AC source 254 may apply an AC signal to coaxial antenna cable 208. The AC signal does not have a DC component nor any DC contribution due to DC block capacitor 256. DC block capacitor 256 acts as a high pass filter for the AC signal. DC block capacitor 256 does not pull down DC source 252. DC source 252 acts as a DC offset to the combined signal on coaxial antenna cable 208. The offset AC signal enables both LEDs 242, 244 to be lit with variable amplitude using the same signal line. The frequency of AC source 254 should be high enough to pass through low frequency DC blocking capacitor 256, but low enough to not pass through high frequency DC block capacitors 224 and 224, thus not affecting the RF performance of the antenna.

According to an embodiment of the present invention, the DC components do not interfere with the RF path due to the low pass filters or RF chokes created by the inductors which may be, for example, wire-wound components or ferrite beads.

According to an embodiment of the present invention, capacitors 222, 224 and 226 act as high pass filters at 50 MHz, 50 MHz, and 100 MHz, respectively and inductors 232, 234 and 236 act as low pass filters at 10 kHz, 10 MHz, and 10 MHz, respectively. DC blocking capacitor 256 is a high pass filter with a cut-off of 20 kHz.

According to an embodiment of the present invention, an RFID reader that includes multiple antennas would have multiple indicator circuitry 202, for example, one coupled to each antenna.

As illustrated, an integrated, low cost indicator on a per-antenna basis can be provided. Indicators may indicate transmitted power status as well as successful tag read acknowledgement. The stimulus and power for the indicators is provided solely via the coaxial cable between the reader circuitry and the antenna.

Although discussed above with reference to RFID like systems, other types of wireless communication systems are intended to be within the scope of the present invention including, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect. In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. An apparatus comprising:
an antenna, the antenna including a coaxial antenna cable; and
indicator circuitry connected to the coaxial antenna cable.

2. The apparatus as recited in claim 1, wherein the indicator circuitry comprises one or more indicators.

3. The apparatus as recited in claim 2, wherein a DC offset voltage is injected into the coaxial antenna cable to power the one or more indicators.

4. The apparatus as recited in claim 2, wherein at least one of the one or more indicators is a light emitting diode.

5. The apparatus as recited in claim 2, wherein at least one of the one or more indicators is a speaker.

6. The apparatus as recited in claim 2, wherein at least one of the one or more indicators indicates a strength of a radio frequency (RF) signal received on the antenna.

7. The apparatus as recited in claim 2, wherein at least one of the one or more indicators indicates a successful tag read.

8. The apparatus as recited in claim 2, wherein at least one of the one or more indicators indicates a successful read count.

9. The apparatus as recited in claim 1, the indicator circuitry comprising a first capacitor and a second capacitor prevent interference with an RF signal on the antenna.

10. The apparatus as recited in claim 1, wherein the indicator circuitry comprises two LEDs and a DC offset voltage injected into the coaxial antenna cable to illuminate at least one of the two LEDs.

11. A method comprising:
providing an indicator circuitry integrated in a coaxial antenna cable.

12. The method as recited in claim 11, wherein the indicator circuitry comprises one or more indicators.

13. The method as recited in claim 12, further comprising injecting a DC offset voltage into the coaxial antenna cable to power the one or more indicators.

14. The method as recited in claim 12, wherein at least one of the one or more indicators is a light emitting diode.

15. The method as recited in claim 12, wherein at least one of the one or more indicators is a speaker.

16. The method as recited in claim 12, wherein at least one of the one or more indicators indicates a strength of a radio frequency (RF) signal received on the antenna.

17. The method as recited in claim 12, wherein at least one of the one or more indicators indicates a successful tag read.

18. The method as recited in claim 12, wherein at least one of the one or more indicators indicates a successful read count.

19. The method as recited in claim 11, the indicator circuitry comprising a first capacitor and a second capacitor prevent interference with an RF signal on the antenna.

20. The method as recited in claim 11, wherein the indicator circuitry comprises two LEDs, the method further comprising injecting a DC offset voltage into the coaxial antenna cable to illuminate at least one of the two LEDs.

21. A radio frequency identification (RFID) reader comprising:
an antenna to send and receive a radio frequency (RF) signal between an RFID tag, the antenna including a coaxial antenna cable; and
indicator circuitry connected to the coaxial antenna cable.

22. The RFID reader as recited in claim 21, wherein the indicator circuitry comprises one or more indicators.

23. The RFID reader as recited in claim 22, wherein a DC offset voltage is injected into the coaxial antenna cable to power the one or more indicators.

24. The RFID reader as recited in claim 22, wherein at least one of the one or more indicators indicates a strength of the RF signal.

25. The RFID reader as recited in claim 22, wherein at least one of the one or more indicators indicates a successful RFID tag read.

26. The RFID reader as recited in claim 22, wherein at least one of the one or more indicators indicates a successful read count.

27. The RFID reader as recited in claim 21, the indicator circuitry comprising a first capacitor and a second capacitor prevent interference with the RF signal.

28. The RFID reader as recited in claim 21, wherein the indicator circuitry comprises two LEDs and a DC offset voltage injected into the coaxial antenna cable to illuminate at least one of the two LEDs.
